(19) United States
(12) Patent Application Publication
(10) Pub. No.: US 2008/0147702 A1
(43) Pub. Date: Jun. 19, 2008

(54) Prediction Method and Device For Evaluating and Forecasting Stochastic Events

(76) Inventor: Michael Bernhard, Karlsruhe (DE)

Correspondence Address: COLLARD & ROE, P.C., 1077 NORTHERN BOULEVARD, ROSLYN, NY, 11576, US

(21) Appl. No.: 10/592,731

(22) PCT Filed: Mar. 16, 2005
(86) PCT No.: PCT/DE2005/000479

§ 371 Date: Sep. 14, 2006

(30) Foreign Application Priority Data
Mar. 16, 2004 (DE) 10 2004 013 020.5

(51) Int. Cl. G06F 17/30

(52) U.S. Cl. 707/102; 707/E17.005

(57) ABSTRACT

The invention relates to a prediction method and device for evaluating and forecasting stochastic events. The problem with prediction methods and devices of this type is that they have a potentially static structure and cannot be adapted to modified data records or modified marginal conditions of the stochastic events. As the invention uses a feedback of the evaluation results, a novel prediction method and a dynamic prediction device can be provided. The method and device are in addition characterized in that they can process the input parameter records and input conditions in real time, while allowing a modified variable allocation to be included via an additional set-up input.

The invention relates to a prediction method and device for evaluating and forecasting stochastic events.

As the information society continues to progress, business processes are being increasingly modeled in databases, in order to obtain useful information and action recommendations for the future by means of the analysis of business processes in the past, if applicable. Electronic product management systems, in particular, make it possible to control business processes that have been extensively automated, by means of the evaluation of complex “if-then event chains.”

The problem of such product management systems, however, is that a number of business processes can only be modeled in “if-then event chains” with difficulty. One speaks about so-called soft facts, in contrast to hard facts, which appear to be accessible to automated handling only with difficulty. An example of this is the evaluation of the probability of a purchase decision by a customer. These questions cannot be answered with the tools of classical analysis or statistics, either.

A possible utilization of such databases has become known in the technical world under the term of “data mining.” This essentially involves extracting decision-relevant data from databases. In this connection, “data mining” is supposed to give the management information and relationships that have remained hidden until now, or have been ignored, because they were considered to be either not relevant for decisions or not analyzable.

The success of “data mining” is also accompanied by new database techniques such as relational or object-oriented databases, flexible client/server technologies, or parallel processors, which have significantly improved the performance and the price/performance ratio of these databases. A number of technologies has become known in the field of “data mining,” such as the artificial neuronal networks, which are essentially understood to be non-linear prediction methods that have been modeled on biological data processing, to a great extent, and structured to be self-adaptive. The so-called Kohonen networks represent an alternative; these involve segmentation methods that are also based on the principle of neuronal networks, and form independent clusters within a larger data collection. Linear regression, for example, represents a classical method of statistical evaluation, whereby here, a possible course of conduct are supposed to be predicted using independent variables. As a rule, rule-based systems are used, which serve to extract the known if/then rules and to verify them, if applicable. The method that is used within the framework of “data mining,” in each instance, depends on the set of questions, in each instance, and the field of use. Neuronal networks and systems of linear regression are particularly used in the case of question sets having a predictive nature. Of course, combinations of the known data mining solutions are also possible, in which it is generally determined empirically what data mining solution represents the best method for which application case.

A concrete use of such methods is described in DE 103 19 493 A1. This involves a remote diagnosis and prediction method for complex systems, particularly in connection with vehicle telematics systems, whereby using the operating data acquired on board a vehicle, which are transmitted to a central diagnosis center, and thus remote monitoring is implemented, but also a prediction, which is supposed to determine the failure probability of individual components, for example.

A method for predicting a parameter that represents the status of a system, particularly a traffic parameter representing the status of a traffic network, and a device for implementing this method, have become known from DE 197 53 034 A1. In this connection, the method can be implemented, in particular, as a program in a traffic control center, whereby so-called progress lines are recorded within a database, which lines show the progression of traffic technology parameters or other parameters, are evaluated. In this connection, more efficient optimization of predictions, particularly of traffic predictions, is supposed to be made possible within the framework of this solution.

A very concrete technical application of such prediction methods is represented by the prediction of the operating behavior or a turbine system, in accordance with the German patent DE 44 24 743 C2. In this connection, additional operating parameters is determined by means of a system-specific system model, on the basis of one or more operating parameters that are given, and the reaction of the modeled turbine system to a desired boundary condition is calculated, taking the desired boundary condition or operating parameter into consideration, and on this basis, the behavior of the monitored operating parameter, i.e. of the turbine system is predicted.

All of the above methods have the problem in common that the prediction methods issue a prediction for the future on the basis of experience in the past. Such a statistical method of procedure generally lacks the required flexibility to deal with the boundary conditions of business processes, which are constantly changing, with the necessary sensitivity. When modeling reality and, in particular, when predicting it, this can only be achieved with dynamic methods, which react to any boundary conditions that have been changed, and ideally can flow into the prediction “on the fly.”

The invention is therefore based on the task of indicating a prediction method and a prediction device for evaluating and forecasting stochastic events, which reacts dynamically to changing boundary conditions, and is configured to be self-adaptive.

The solution for the task according to the invention is accomplished by means of a prediction method according to claim 1 as well as a prediction device according to claim 12.

Advantageous embodiments can be derived from the dependent claims 2 to 11 and 13 to 18, respectively.

Because an event data set is first applied to a processing unit, within the framework of the prediction method according to the invention, which unit is replied to with a binary event value, which value is then passed to the subsequent evaluation unit, the evaluation result of which in turn is fed back to another input of the processing unit, there is feed-back between the input variables and the output variables, in the sense of a simple regulation circuit, so that these changed input variables result in changed event values, which are included in the prediction method by way of feed-back.

In this connection, a significant intervention possibility in the dynamic evaluation process is represented by the additional cut-off input of the processing unit, with which the ratio of the binary event values relative to one another can be set. In concrete terms, the event set could contain a description of an offer and a customer data set, whereby the binary event value represents a digital representation of a purchase offer to the customer yes/no, so that a cut-off input in the sense of a reference value can be set, as to how many customers to whom a purchase offer is submitted should accept this offer.

In this connection, the prediction method according to the invention is carried out in two separate methods, which are, however, linked with one another, and are controlled by a processing unit and an evaluation unit. In this connection, the processing unit represents the control center of the prediction method, and thereby is responsible for cycling and control of the prediction method as a whole.

Aside from the digital evaluation result at the output of the processing unit, the processing unit has two additional outputs for outputting two characteristic vectors, in each instance, where one characteristic vector comprises the target parameter value, while in the case of the other characteristic vector, the value of the target parameter is not yet occupied. Both characteristic vectors are then handed over to the subsequent evaluation unit, which then determines the target parameter value, using an evaluation of the characteristic vectors, which value is fed back to an additional score input of the processor unit.

Within the framework of the practical implementation of the method according to the invention, it has proven itself to apply the event data set to the input of the processor unit in the form of an n-tuple, whereby the dimension of the vector is changeable, therefore the value n of the n-tuple is changeable. In this connection, the n-tuple does not necessarily have to be standardized. It usually consists of key value pairs. With a change in the dimensions of the event data set, or of the vector given to the processing unit, respectively, it is possible to react to changed boundary conditions with a changed event data set, so that in the course of the evaluation of one and the same business process, it is possible to work with different event data sets, if necessary. In this connection, changed boundary conditions do not require that the prediction and evaluation process be broken off, with the result that the previous prediction and evaluation results would be lost for the further evaluation. Instead, the learning process can be dynamically adapted by means of self-adaptation of the evaluation system, by means of a simple adaptation of the input data set and/or a change in dimensions.

Another significant advantage of the method according to the invention lies in the fact that the evaluation result of the evaluation unit that is fed back to the return input of the processor unit is a numerical value and therefore easily comprehensible. For example, a high evaluation result stands for a high sales volume of the customer, and a low evaluation result stands for a correspondingly low sales volume. This significantly facilitates the practical use of the prediction method. The variable returned to the return input therefore already represents a model of a fact.

In an advantageous embodiment, the evaluation process that takes place in the evaluation unit that follows the processing unit represents a self-adaptive system that has an incremental learning mechanism at its disposal. In this connection, the method must first be initiated with predefined training event data sets, due to lack of corresponding experience in the past, which sets are sequentially applied to the processing unit and passed on to the subsequent evaluation unit in the form of the characteristic vectors described above, with the result that a first optimization of the prediction method takes place, whereby an improvement of the system already takes place with an increasing number of event data sets that are processed, particularly also real event data sets.

In this connection, the dynamics of the prediction of the prediction method also become clear in that the evaluation results, in each instance, are assigned a time-related evaluation and, as a function of this, a priority weighting. The older evaluations have a lower weight than the more recent ones, so that changing boundary conditions can also be appropriately taken into consideration in this regard. This functionality of the evaluation method is accurately described as a “forget function.”

The dynamics of the prediction method according to the invention are reflected, among other things, also by an additional set-up input of the processing unit, by way of which it is possible to enter additional parameters into an on-going evaluation, or to define the parameters of the event data set in changed manner. In other words, parameterization, i.e. pre-definition of the event data sets applied to the input of the processing unit takes place by way of the set-up input. By way of the set-up input, additional variables can be entered “on the fly,” and therefore the dimension of the event data set can be expanded.

In order to be able to take the learning progress of the prediction method appropriately into consideration, at least three different method runs of the prediction are applied within the prediction method. In a first method run, the event data sets are merely filed in a cache memory assigned to the processing unit, and for the remainder, the number of the event data sets that have been processed, as well as the digital evaluation results are counted. For example, a product is offered to every customer represented by an event data set, and it is reported back to the return input, for every customer, as an evaluation result, whether or not the purchase decision was positive. In this connection, therefore, output constantly occurs at the response output 1, in this phase. The completed event data sets therefore “train” the method. The quality of the prediction is measured in parallel. For this purpose, a corresponding counter is assigned to the processing unit. When a defined threshold value and therefore a certain learning result is reached, a switch takes place from a first method run to a second method run, whereby now it depends on the evaluation whether an event value of 0 or 1 occurs at the response output. When another threshold value is reached, a switch can take place to another, third method run, in which the method as such remains unchanged, but the work is carried out with changed parameter values, in other words already with the first results of the evaluation process. In this way, a further optimization of the prediction method can again be achieved. Of course, further adaptation of the parameterization and therefore additional different method runs of the prediction can be implemented, within the scope of the invention.

In the sense of a dynamic prediction method, it has proven itself if the change in the parameters is represented in a so-called change curve, which simultaneously represents a so-called early warning system, in order to react to changing conditions with changing defaults, if necessary. For example, the prices of the offers to the customers can be adapted to market events, in each instance.

The method is ideally implemented in connection with a prediction device according to claim 12.

This prediction device can ideally be operated in connection with a conventional data processing system, whereby this data processing system can stand in connection with a customer database of a vendor, whereby the prediction device is additionally connected with a telephone system of the customer data vendor. In this connection, the individual customer data sets can then be selected as a function of possible customer telephone calls, for example using the customer telephone number or other identification characteristics, whereby then a prediction of the purchase decisions of the customer to be expected, with regard to various offer possibilities, is then displayed by way of a display unit connected with the prediction device. Such a system can be advantageously used in connection with a call center, for example, whereby then, the call center employee, in each instance, sees a display as to what goods or what service should be offered to the customer within the framework of the call, as a function of the customer who is calling, in order to have an increased probability for a positive purchase decision.

In the following, the invention will be explained in greater detail using an exemplary embodiment shown only schematically in the drawing.

This shows:

FIG. 1: a workstation of a call center with the prediction device connected, in a block schematic,

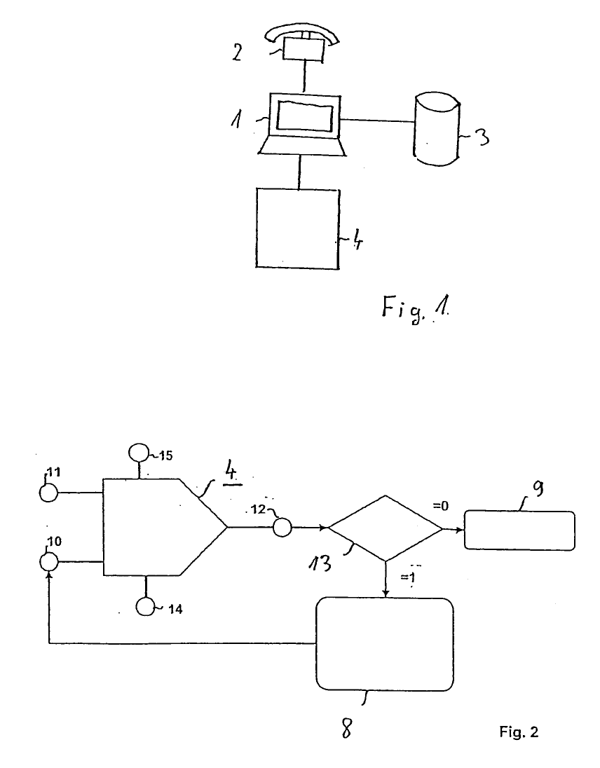

FIG. 2: a prediction method of the prediction device according to FIG. 1, in a block schematic,

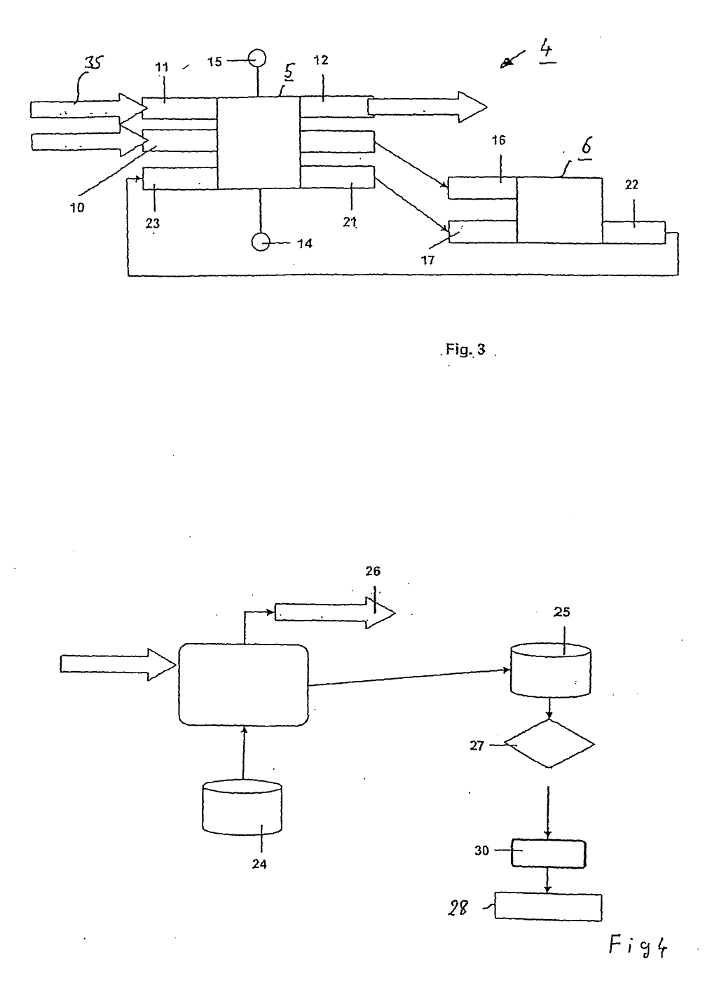

FIG. 3: the prediction method according to FIG. 2 in a more detailed block schematic,

FIG. 4: another detail with regard to processing of the event data sets of the prediction method, in a block schematic,

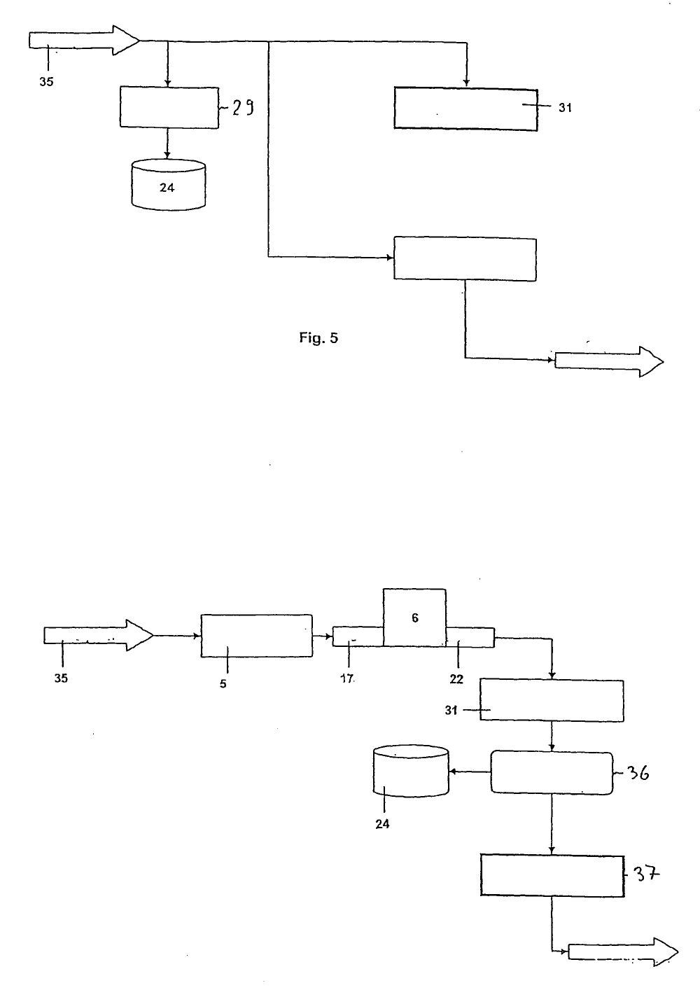

FIG. 5: a first method sequence of the prediction method, in a block schematic,

FIG. 6: a second method sequence of the prediction method, in a block schematic,

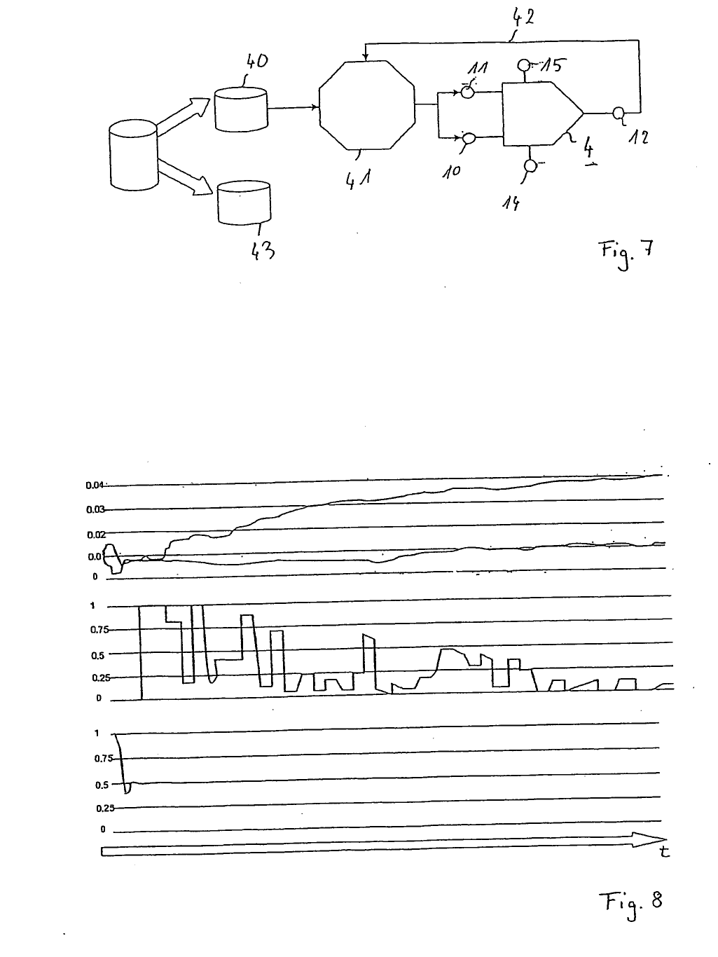

FIG. 7: a method for creating so-called score cards,

FIG. 8: a progress line with the progression of stochastic events, without using the prediction method, in comparison with a progress line using the prediction method, in a diagram representation, in each instance, with reference to an input variable.

In FIG. 1, a usual workstation in a call center is shown as an example for the use of the prediction method according to the invention, i.e. the prediction device according to the invention. Such a workstation consists, first of all, of a terminal 1 or a computer unit of the call center employee, in each instance, which is connected with the telecommunications system 2 of the call center. In addition, both the telecommunications system 2 and the terminal 1 stand in a data connection with a customer database 3 of the vendor working together with the call center. The vendor can be any participant in the business process, such as a mail-order company, whereby the call center can be either an external or internal facility of the vendor, which has access to the aforementioned customer database 3 of the vendor, in any case. Within the framework of the invention, the terminal 1 of the call center employee is additionally connected with a prediction device 4. The prediction device 4 can either be connected with its own display device, or can use the terminal 1 of the employee as a display device.

The usual use of the workstation shown in FIG. 1 consists in the fact that a customer is put through, by way of the telecommunications system 2, to the user terminal 1 of the call center employee, in each instance, whereby the corresponding customer data are retrieved from the customer database 3 on the basis of a customer identification that has been queried previously, or simply the customer's telephone number, and are displayed on the terminal 1. At the same time, the data retrieved from the customer database 3 are handed over to the prediction device 4, as event data sets, in connection with one or more possible offers that can be submitted to the caller, which device thereupon reacts with a prediction with regard to the purchasing behavior of the customer or a probability evaluation for a possible purchase, and displays this on the terminal 1. As a function of the result reported to the employee, in each instance, an individual offer is then submitted to the caller, whereby the real purchase decision of the customer then flows into the customer database 3, and therefore flows into the evaluation by the prediction device 4 the next time the same customer calls.

According to the representation in FIG. 2, the prediction device 4, which can be implemented in the form of a computer unit, not shown in any detail, essentially consists of two modules that stand in a data connection with one another.

As was already mentioned, the event data sets are handed over to the prediction device 4. These are vectors, so-called n-tuples, which are applied to a request input 11 of the prediction device 4. Every event data set applied to the request input 11 of the prediction device 4 is answered with a digital event value 0 or 1 at the response output 12 of the prediction device 4. In the present case, this can involve the recommendation to make an offer to the customer (event value=1) or not. The response output 12 is followed by a query unit 13 that rejects the event data set applied to the request input 11, in a deletion step 9, in case the event value output at the response output 12 is 0, or initiates further processing. For this purpose, the offer is now submitted to the customer, in other words an external process 8 is turned on, and the customer reaction is fed back to a return input 10 of the prediction device 4 in the form of a numerical evaluation result, by way of the feed-back coupling path 7, as events progress. This can simply be the feed-back that the customer has purchased something, or how great the sales volume achieved is, or something similar. The

As is also evident from FIG. 2, the prediction device 4 is additionally provided with a cut-off input 14, at which the ratio of the digital event values relative to one another, in other words the percentage of events evaluated as 1, can be set with reference to the total number of event data sets.

The prediction device 4 is parameterized by way of an additional set-up input 15. This is particularly understood to mean that the number of dimensions, in other words the number n of the n-tuple of the event data sets applied at the request input 11 is established by way of the set-up input 15, and furthermore the parameters contained in the event data sets can be defined in terms of form and name, as well as type. These are so-called key value pairs, such as “age: 35.”

A more detailed representation of the prediction device 4 is given in FIG. 3. According to the representation in FIG. 3, the prediction device comprises a processing unit 5 with subsequent evaluation unit 6. In this connection, the subsequent evaluation unit 6 has at least two inputs 16, 17. These are a training input 16 and a score input 17, which are connected with a training output 20 and a request output 21 of the processing unit 5, in each instance. As was already explained above, the subsequent evaluation process in the evaluation unit 6 is initiated as a function of whether an input value 1 or 0 is output at the response output 12, whereby the event value 1, in the present example, might stand for the recommendation to submit an offer to the customer, stand for.

The two inputs 16, 17 of the evaluation unit 6 have the characteristic vectors output by the processing unit applied to them, in each instance, whereby the training input 16 serves for adaptation of the evaluation processes applied in the evaluation unit 6, and therefore demands a characteristic vector with an occupied target variable, whereby a characteristic vector is applied at the score input 17, the target variable of which is not occupied.

For each characteristic vector pair that is applied to the inputs 16 and 17, in this regard, an evaluation result is output at a score output 22. The evaluation value output at the score output 22 represents a numerical number that corresponds to the target variable already mentioned. This target variable, i.e. this evaluation value is then fed back to an additional score input 23 of the processing unit 5. The evaluation value determined by the evaluation unit 6 therefore flows into the further evaluation by the prediction device 4.

The concrete processing of the values fed back to the processing unit 5 by the evaluation unit 6, at the return input 10, is shown in FIG. 4.

First, each of the event data sets reported to the prediction device 4 is stored in a so-called request cache 24, whereby the event vector previously stored in the request cache 24 is sought out, as soon as the fed-back evaluation values are applied to the return input 10 of the processing unit 5, on the basis of these data sets, and this vector is enriched by the value fed back by the evaluation unit 6, and subsequently the complete data set, in other words n-tuple comprise the event data set and the evaluation set, is stored in a training cache 25. As soon as the training cache 25 is full, the evaluation unit 6 is trained using the content of the training cache 25. In the case that the values of the event data set fed back by the processing unit 5 cannot be found in the request cache 24, an error message 26 is output.

In this connection, a threshold value query 27 is assigned to the training cache 25, by way of which query the system checks whether the training cache 25 has already been filled, in other words a predetermined number of event data sets has been applied to this memory element. As soon as this number has been reached, these event data sets are used to improve the parameterization of the evaluation unit 6, for example, whereby the model on which the prediction device 4 is based is trained in a training step 30, and subsequently the training cache 25 is emptied in an emptying step 28.

According to FIGS. 5 and 6, at least three different method runs can be differentiated from one another in the case of the prediction method according to the invention, whereby it is dependent on the learning result and the learning progress of the prediction method according to the invention, in each instance, which of the possible method runs is used. The different method runs have their effect, in particular, in the processing of the event data sets applied at the input of the processing unit, the so-called requests 35. In the first method run, the requests 35 are written in a request cache 24 assigned to a writing step of the processing unit, without being changed, and the threshold value counter 31 is increased by one for every request 35 whereby the integrated response counter is also increased by one for every request 35 that is answered with the response 1. In this first phase, however, the event value=1 is always output at the response output 12. In other words, at first, a purchase offer is generally submitted to the customer.

As soon as one or both counters 31 reach a predetermined threshold value, and therefore the prediction method has collected sufficient experience or quality, a switch is made from the first method run according to FIG. 5 to a second method run according to FIG. 6, with the proviso that in the further proceedings, only those event data sets that have led to a response=1 will be stored in the aforementioned request cache 24. Furthermore, the internal parameter sets of the evaluation unit 6 are adapted to the changed situation. Now, however, the evaluation unit 6 causes either an event value 1 or 0 to be output at the response output 12. Therefore a response query 37 must be switched ahead of the parameter setting 37. In other words, an evaluation as to how well the prediction device 4 is already working, in other words approximately how often the customer accepts the purchase offer, is carried out in parallel. This relationship, in turn, is monitored with a threshold value counter 31.

When a further defined threshold value is reached, a switch is made from the second method run to a third method run, which essentially differs from the second method run only in that the internal parameters used in the evaluation unit 6 are changed as a function of the learning result of the prediction method.

A possible use of the method explained above consists in using dynamic prediction methods for the creation of statistical evaluation tables, so-called “scoring cards.” According to the representation in FIG. 8, the prediction device 4 can be preceded by a training database 40, from which the simulation unit 41, which also precedes the prediction device, takes data sets in an endless loop 42, and passes them to the prediction device 4 as a sequential data stream, until a desired prediction quality has been reached. The data stored in a parallel validation database 43 serve to check the quality of the prediction device 4 with an independent data set, if necessary.

The result of the prediction method according to the invention, i.e. the prediction device 4 according to the invention, is shown in FIG. 9. This involves three progress lines plotted over time, in three diagrams disposed one above the other. In this connection, the progress line of the positive purchase decisions, in other words the return values 1, is plotted in reference to the total number of processed event data sets. In this connection, a value of 0.5 is set at the cut-off input. After a relatively short period of time, when processing the entire data set, an offer success rate of approximately 4% is found over the time of approximately 11,800 data sets, with the meaning that 4% of the customers asked actually purchased the product offered to them. As is clearly evident in the upper progress line, the positive return curve very quickly and markedly approaches the desired sales result. In the above example, a so-called scoring process with 11,000 event data sets was evaluated, whereby as a unique feature, the product offered to the customer was changed in the case of approximately 5,800 data. In this way, it was supposed to be documented that the prediction method according to the invention can easily be adapted to changed conditions. The change in the product is reflected as a peak in the change curve, but without the return or the prediction quality being clearly deteriorated thereby.

Above, therefore, a prediction device is described that makes it possible, essentially using known regulation technology principles, particularly feed-back, to be adapted dynamically to changed economic boundary conditions, and can be changed even during its running time, in other words “on the fly.”

### REFERENCE SYMBOL LIST

1 terminal
2 telecommunications system
3 customer databases
4 prediction device
5 processing unit
6 evaluation unit
7 feed-back path
8 external process
9 deletion step
10 return input
11 request input
12 response output
13 query unit
14 cut-off input
15 set-up input
16 training input
17 score input
20 training output
21 request output
22 score output
23 additional score input
24 request cache
25 training cache
26 error message
27 threshold value query
28 emptying step
29 writing step
30 training step
31 threshold parameter counter
32 supplementation step
33 return cache
35 request
36 response query
37 parameter setting
40 training database
41 simulation unit
42 endless loop
43 validation database

1-18. (canceled)

19. Prediction method for dynamically evaluating and forecasting stochastic events, in which an event data set is applied to a request input (11) of a processing unit (5) as a request (35), in the form of a defined, but not necessarily standardized, n-tuple, and each event data set is answered with a binary event value, 0 or 1, at a response output (12) of the processing unit (5), whereby then the event data set is rejected or passed to a subsequent evaluation unit (6), as a function of this event value, the evaluation result of which unit is fed back to a return input (10) of the processing unit (5), whereby the parameters of the event data sets can be defined by means of a set-up input (15) of the processing unit (5), whereby additional parameters can be entered into and defined in the event data set to be processed, “on the fly,” or parameters can be eliminated, by way of the set-up input (15).

20. Prediction method according to claim 19, wherein the process unit (5) has an additional cut-off input (14), at which the ratio of the binary event values relative to one another is set.

21. Prediction method according to claim 19, wherein the processing unit (5) and the subsequent evaluation unit (6) are switched in the manner of a simple, self-adapting regulation circuit, whereby cycling and control of the prediction method as a whole are carried out by the processing unit (5).

22. Prediction method according to claim 19, wherein at the subsequent evaluation unit (6), a characteristic vector, in each instance, is handed over to two separate inputs (16, 17), whereby the one characteristic vector, in each instance, comprises a target parameter value, and the other characteristic vector, in each instance, is not occupied with regard to the target parameter, and for each paid of characteristic vectors handed over to the evaluation unit (6), a target parameter value is output, after the evaluation process has been run through, whereby this target parameter value is fed back to an additional score input (23) of the processing unit (5).

23. Prediction method according to claim 19, wherein the event data sets are applied to the request input (11) of the processing unit (5) in the form of an n-tuple, whereby n is changeable.

24. Prediction method according to claim 19, wherein the evaluation result fed back to the return input (10) of the processing unit (5) is a numerical value.

25. Prediction method according to claim 19, wherein the evaluation process applied in the evaluation unit (6) has an incremental learning mechanism for improving the evaluation result, in which first optimization of the evaluation process by means of a defined number of predetermined training event data sets takes place, which are applied sequentially, whereby subsequently, further optimization of the evaluation process is provided, in such a manner that a time-related evaluation of the evaluation results takes place, in such a manner that older evaluation results flow into the self-adaptation of the evaluation process with weaker priority than more recent evaluation results.

26. Prediction method according to claim 19, wherein the prediction method is divided, depending on the learning progress, into at least three method runs that can be differentiated, whereby in a first method run, the event data sets to be evaluated are written into a request cache (24) of the processing unit (5), and fundamentally evaluated with the event value 1, and the evaluation results returned to the return input (11) are stored and their quality is evaluated, whereby when a defined threshold value of the quality is reached, a switch takes place to a second method run, in which now the self-adapting evaluation process that takes place in the evaluation unit (6) is interposed, and it now depends on this evaluation whether 1 or 0 is output as the event value at the response output (12), whereby in the further proceedings, only the event data sets in connection with which the event value 1 was output at the response output (12) are stored in the request cache (24), and finally, when a further threshold value of the threshold parameter counter (31) is reached, a third method run is started, in the course of which the work is carried out with a changed parameter data set, within the evaluation unit (6).

27. Prediction method according to claim 19, wherein the changes in the parameter set are detected and displayed on a display device, preferably in the form of a change curve.

28. Prediction method according to claim 19, wherein a sequential training data stream is passed to the prediction method, by way of an endless loop, until the prediction method has reached a predetermined quality and/or stability, and the results are filed in a score card.

29. Prediction device for dynamically evaluating and predicting stochastic events, comprising a processing unit (5) and an evaluation unit (6), for implementing an evaluation process, which are connected with one another in the form of a simple, self-adapting regulation circuit, whereby the processing unit (5) has a request input (11) to which an event data set in the form of an n-tuple is applied, in each instance, and a response output (12) for outputting a digital event value, 0 or 1, in response to the event data set, in each instance, is provided, whereby either feed-back of the evaluation result of the evaluation unit (6) to an additional score input (23) of the processing unit (5) is provided as a function of the event value, with the interposition of the evaluation unit (6), or no further processing of the event data set is provided, and the processing unit (5) has an additional set-up input (15), by way of which the type and number of the variables of the event data set can be entered and/or changed “on the fly.”

30. Prediction device according to claim 29, wherein the processing unit (5) has an additional cut-off input (14) at which the ratio of the digital event values relative to one another can be set.

31. Prediction device according to claim 29, wherein a request cache (24) for intermediate storage of the event data sets as well as a counter for storing the number of the event data sets answered with the event value 1 is assigned to the processing unit (5).

32. Prediction device according to claim 29, wherein the evaluation device (6) that follows the processing unit (5) has two separate inputs (16, 17), to which two characteristic vectors are applied, in each instance, whereby one of the characteristic vectors, in each instance, has a target variable, and in the case of the other characteristic vector, in each instance, the target value is not occupied.

33. Prediction device according to claim 29, wherein the processing unit (5) and the evaluation unit (6) are disposed in a common computer system, whereby this computer system is connected with a display unit (1) and this computer system stands in data connection with a customer database (3), whereby the event data set comprises the purchase decision of the customers in connection with possible offers and/or other parameters.

34. Prediction device according to claim 29, wherein the prediction device (4) is connected with a telephone system (2), and the customer data set from the customer database (3) is played for the prediction device (4) as a function of the telephone number of the caller, in each instance, and subsequently, a prediction of the purchase decision is output by way of the display device (1), by means of one or more event data sets that represent possible offers to the customer, in each instance.
